(19) United States
(12) Patent Application Publication
(10) Pub. No.: US 2022/0219410 A1
(43) Pub. Date: Jul. 14, 2022

(54) PANEL FOR A VEHICLE

(71) Applicant: Motus Integrated Technologies, Holland, MI (US)

(72) Inventor: Schuyler Joseph DeVries, Zeeland, MI (US)

(21) Appl. No.: 17/576,102

(22) Filed: Jan. 14, 2022

Related U.S. Application Data
(60) Provisional application No. 63/137,263, filed on Jan. 14, 2021.

(51) Int. Cl. B29C 70/34; B29C 70/18; B29D 99/00

(52) U.S. Cl. CPC B29C 70/347; B29K 2075/00; B29D 99/001; B29C 70/18

(57) ABSTRACT

A panel for a vehicle includes a core formed from fibers and a thermoset resin. The panel also includes a first barrier layer positioned on a first side of the core and a second barrier layer positioned on a second side of the core, opposite the first side. Each of the first and second barrier layers is configured to block flow of the thermoset resin from the core during a panel forming process.

### CROSS REFERENCE TO RELATED APPLICATION

This application claims priority from and the benefit of U.S. Provisional Application Ser. No. 63/137,263, entitled “PANEL FOR A VEHICLE”, filed Jan. 14, 2021, which is hereby incorporated by reference in its entirety.

### BACKGROUND

The present disclosure relates generally to a panel for a vehicle.

Certain panels of a vehicle (e.g., headliner, underbody shield, wheel well liner, trunk trim, heat shield, tunnel shield, etc.) include a core formed from bi-component fibers. The bi-component fibers may include a combination of polyethylene terephthalate (PET) fibers and thermoplastic coated PET fibers. Unfortunately, panels having a bi-component fiber core may have reduced performance at higher temperatures (e.g., within an interior of a vehicle) due to the temperature-dependent properties of the thermoplastic coating and the PET fibers.

### BRIEF DESCRIPTION OF THE INVENTION

In certain embodiments, a panel for a vehicle includes a core formed from fibers and a thermoset resin. The panel also includes a first barrier layer positioned on a first side of the core and a second barrier layer positioned on a second side of the core, opposite the first side. Each of the first and second barrier layers is configured to block flow of the thermoset resin from the core during a panel forming process.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a vehicle that may include at least one panel having a core formed from fibers and a thermoset resin;

FIG. 2 is a perspective view of part of an interior of the vehicle of FIG. 1;

FIG. 3 is an exploded view of an embodiment of a panel that may be employed within the vehicle of FIG. 1; and

FIG. 4 is a view of a series of diagrammatical steps of an embodiment of a method of manufacturing a panel that may be employed within the vehicle of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

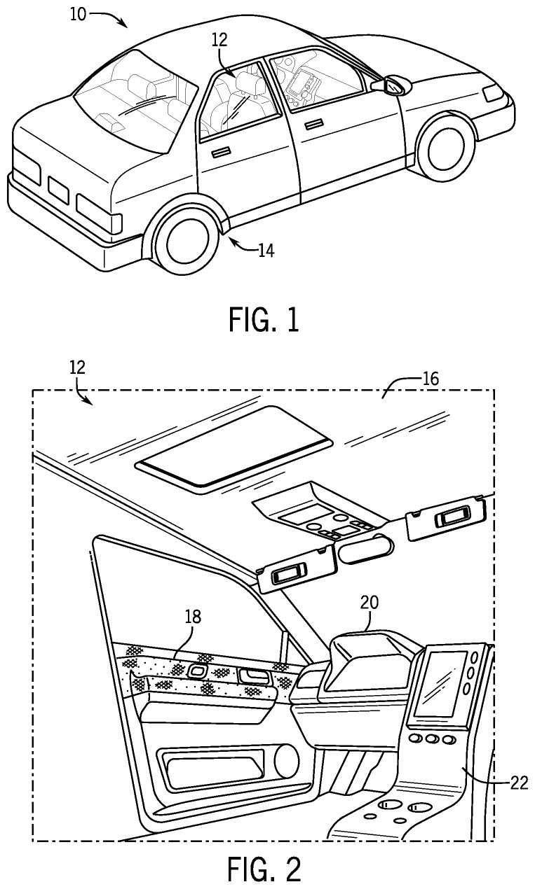

FIG. 1 is a perspective view of an embodiment of a vehicle that may include at least one panel having a core formed from fibers and a thermoset resin. One or more panels may be disposed within an interior 12 of the vehicle 10. For example, one or more panels may form a headliner of the vehicle, and/or one or more panels may form a trunk liner of the vehicle. Additionally or alternatively, one or more panels may form a portion of the exterior 14 of the vehicle 10. For example, one or more panels may form a portion of a wheel well of the vehicle 10, one or more panels may form an underbody shield of the vehicle 10, one or more panels may form a tunnel shield of the vehicle 10, or a combination thereof. Furthermore, one or more panels may be positioned proximate to a warm component of the vehicle (e.g., engine, exhaust, battery, etc.) to form a heat shield.

In certain embodiments, at least one panel includes a core formed from fibers (e.g., polyethylene terephthalate (PET) fibers) and thermoset resin (e.g., methylene diphenyl diisocyanate (MDI)). The panel also includes a first barrier layer positioned on a first side of the core and a second barrier layer positioned on a second side of the core, opposite the first side. The first barrier layer may include a film and/or the second barrier layer may include a film. The barrier layers are configured to block (e.g., substantially block or entirely block) flow of the thermoset resin from the core during the panel forming process. Because the core of the panel is formed from fibers and thermoset resin, the panel may be readily formed into complex shapes within a tool/mold (e.g., as compared to a panel having a core formed from bi-component fibers including thermoplastic coated fibers and non-thermoplastic coated fibers). Furthermore, because the core is formed from fibers and thermoset resin, the core may be less expensive than a core formed from bi-component fibers including thermoplastic coated and non-thermoplastic coated fibers. In addition, because the core includes thermoset resin instead of thermoplastic resin, deformation of the panel at higher temperatures (e.g., within the interior of the vehicle) may be reduced (e.g., as compared to a core formed from bi-component fibers including thermoplastic and non-thermoplastic coated fibers).

FIG. 2 is a perspective view of part of the interior 12 of the vehicle of FIG. 1. In the illustrated embodiment, a headliner 16, a door panel 18, an instrument panel 20, and a center console 22 are disposed within the interior 12 of the vehicle. The panel disclosed herein may form at least a portion of the headliner 16, at least a portion of the door panel 18, at least a portion of the instrument panel 20, at least a portion of the center console 22, at least a portion of another suitable element of the vehicle interior, or a combination thereof. Furthermore, as previously discussed, the panel disclosed herein may form at least a portion of an exterior component of the vehicle, such as the wheel well/wheel well liner.

In certain embodiments, the panel is formed by a process including applying a liquid thermoset resin to a mat having fibers to form a core. Next, a catalyst and/or a catalyst activator (e.g., water) is applied to a first side of the core and to a second side of the core, opposite the first side. A first barrier layer is then applied to the first side of the core, and a second barrier layer is applied to the second side of the core. The core, the first barrier layer, and the second barrier layer are compressed and heated within a tool to form the panel. The first and second barrier layers are configured to block (e.g., substantially block or entirely block) flow of the thermoset resin from the core during the compression and heating step. As previously discussed, the fibers may include PET fibers, and/or the thermoset resin may include MDI. Because the core of the panel is formed from fibers and thermoset resin, the panel may be readily formed into complex shapes within the tool (e.g., as compared to a panel having a core formed from bi-component fibers including thermoplastic coated fibers and non-thermoplastic coated fibers). Furthermore, because the core is formed from fibers and thermoset resin, the core may be less expensive than a core formed from bi-component fibers including thermoplastic coated and non-thermoplastic coated fibers. In addition, because the core includes thermoset resin instead of thermoplastic resin, deformation of the panel at higher temperatures (e.g., within the interior of the vehicle) may be reduced (e.g., as compared to a core formed from bi-component fibers including thermoplastic and non-thermoplastic coated fibers).

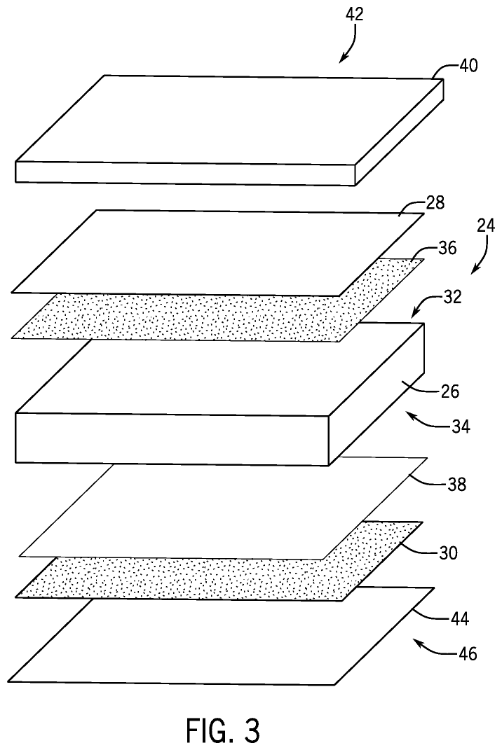

FIG. 3 is an exploded view of an embodiment of a panel 24 that may be employed within the vehicle of FIG. 1. In the illustrated embodiment, the panel 24 includes a core 26 formed from fibers and a thermoset resin. In certain embodiments, the fibers include polyethylene terephthalate (PET) fibers. For example, in certain embodiments, the fibers may only include PET fibers. However, in other embodiments, the fibers may include other suitable type(s) of fibers (e.g., alone or in combination with the PET fibers), such as natural fibers, polypropylene (PP) fibers, graphene fibers, other suitable type(s) of fibers, or a combination thereof. The fibers may be arranged in any suitable configuration, such as in a woven pattern (e.g., woven roving), in a random pattern (e.g., chopped strand mat), in other suitable pattern(s), or a combination thereof. In certain embodiments, none of the fibers are coated with a thermoplastic resin configured to melt during the panel forming process. However, in other embodiments, at least a portion of the fibers are coated with thermoplastic resin configured to melt during the panel forming process. Furthermore, in certain embodiments, the thermoset resin includes methylene diphenyl diisocyanate (MDI). For example, in certain embodiments, the thermoset resin may only include MDI. However, in other embodiments, the thermoset resin may include other suitable type(s) of thermoset resin(s) (e.g., alone or in combination with the MDI), such as polyurethane (PUR), other suitable type(s) of resin(s), or a combination thereof. The weight of the core may be about 100 to about 1500 grams per square meter (gsm), about 200 to about 900 gsm, or about 300 to about 600 gsm.

In addition, in the illustrated embodiment, the panel 24 includes a first barrier layer 28 and a second barrier layer 30. As illustrated, the first barrier layer 28 is positioned on a first side 32 of the core 26, and the second barrier layer 30 is positioned on a second side 34 of the core 26, opposite the first side 32. The barrier layers are configured to block (e.g., substantially block or entirely block) flow of the thermoset resin from the core 26 during the panel forming process. Each barrier layer may be formed from any suitable material configured to block flow of the thermoset resin. For example, the first barrier layer 28 may include a film, and/or the second barrier layer 30 may include a film. In certain embodiments, at least one barrier layer (e.g., the second barrier layer 30) may include a film formed from polyethylene and having a PP core. In addition, in certain embodiments, at least one barrier layer (e.g., both barrier layers) may be formed from a fibrous material (e.g., including glass fibers, carbon fibers, graphene fibers, polymeric fibers, natural fibers, other suitable type(s) of fibers, or a combination thereof). For example, the fibers of the fibrous material may be tightly woven to establish a low/zero porosity, thereby blocking (e.g., substantially blocking or entirely blocking) flow of the thermoset resin from the core 26 during the panel forming process. Furthermore, in certain embodiments, at least one barrier layer (e.g., both barrier layers) may be formed from a combination of film and fibrous material. Each barrier layer may have any suitable thickness (e.g., 0.5 mil/0.0127 mm, 1 mil/0.0254 mm, 1.5 mil/0.0381 mm, 2 mil/0.0508 mm, 2.5 mil/0.0635 mm, 3 mil/0.0762 mm, etc.). While the panel 24 includes two barrier layers in the illustrated embodiment, in other embodiments, at least one of the barrier layers may be omitted (e.g., to facilitate off-gassing, etc.).

In certain embodiments, one or more first additional layers 36 may be disposed between the first barrier layer 28 and the core 26. The first additional layer(s) 36 may include a first glass mat and/or a first PET scrim. Furthermore, in certain embodiments, one or more second additional layers 38 may be disposed between the second barrier layer 30 and the core 26. The second additional layer(s) 38 may include a second glass mat and/or a second PET scrim. Each glass mat may include glass fibers arranged in any suitable configuration, such as in a woven pattern (e.g., woven roving), in a random pattern (e.g., chopped strand mat), in other suitable pattern(s), or a combination thereof. Because each glass mat is positioned inward of the respective barrier layer, the glass mat may be emulsified by the thermoset resin (e.g., MDI) from the core 26 during the panel forming process, thereby establishing a structural layer that may increase the bending resistance of the panel 24. The weight of each glass mat may be about 40 to about 500 gsm, about 60 to about 300 gsm, or about 100 to about 200 gsm. While glass mats are disclosed above, at least one mat may include fibers of different suitable type(s) (e.g., alone or in combination with the glass fibers), such as carbon fibers, graphene fibers, polymeric fibers, natural fibers, other suitable type(s) of fibers, or a combination thereof. Furthermore, while PET scrims are disclosed above, in certain embodiments, at least one scrim may be formed from another suitable material. While the illustrated panel 24 includes the first additional layer(s) 36 and the second additional layer(s) 38 in the illustrated embodiment, in other embodiments, at least one of the first additional layer(s) or the second additional layer(s) may be omitted. For example, in certain embodiments, at least one barrier layer (e.g., both barrier layers) may directly contact the core.

In certain embodiments, the panel 24 includes a cover layer 40 positioned on an opposite side of the first barrier layer 28 from the core 26. The cover layer 40 is configured to form a show surface 42 of the panel 24 (e.g., facing the vehicle interior, forming an exterior surface of the vehicle, etc.). For example, in certain embodiments, the cover layer 40 may include an outer layer (e.g., leather, synthetic fabric, cloth, etc.), a scrim layer, and a foam layer disposed between the outer layer and the scrim layer. Furthermore, in certain embodiments, the first barrier layer 28 may be coupled to the cover layer 40 (e.g., via an adhesive) before the core/layers are disposed within the tool/mold to form the panel 24. In addition, in certain embodiments, the first barrier layer 28 may couple the cover layer 40 to the first additional layer(s) 36 or to the core 26 during the panel forming process. For example, in certain embodiments, the first barrier layer 28 may include a film (e.g., polyethylene film, etc.) configured to bond to the cover layer 40 and to the first additional layer(s) 36/core 26 during the panel forming process. While a cover layer including an outer layer, a scrim layer, and a foam layer is disclosed above, in certain embodiments, at least one of the outer layer, the scrim layer, or the foam layer may be omitted, and/or the cover layer may include at least one other/additional suitable layer. In addition, in certain embodiments, the cover layer may be omitted.

Furthermore, in certain embodiments, the panel 24 includes a scrim layer 44 positioned on an opposite side of the second barrier layer 30 from the core 26. The scrim layer 44 is configured to form a rear surface 46 of the panel 24. The scrim layer 44 may have any suitable weight, such as about 10 to about 50 gsm, about 15 to about 25 gsm, or about 17 gsm. Furthermore, the scrim layer 44 may be formed from any suitable material, such as PET. In addition, in certain embodiments, the scrim layer may be omitted. In certain embodiments, the second barrier layer 30 may couple the scrim layer 44 to the second additional layer(s) 38 or to the core 26 during the panel forming process. For example, in certain embodiments, the second barrier layer 30 may include a film (e.g., polyethylene film, etc.) configured to bond to the scrim layer 44 and to the second additional layer(s) 38/core 26 during the panel forming process. Furthermore, in certain embodiments, at least one of the illustrated barrier layers may be omitted to facilitate bonding between the core and the cover layer and/or to facilitate bonding between the core and the scrim layer. In such embodiments, the cover layer/scrim layer may function as a barrier layer (e.g., if the cover layer/scrim layer is configured to block flow of the thermoset resin from the core during the panel forming process). In addition, the panel may include any other suitable layer(s) disposed at any suitable location(s) within the panel.

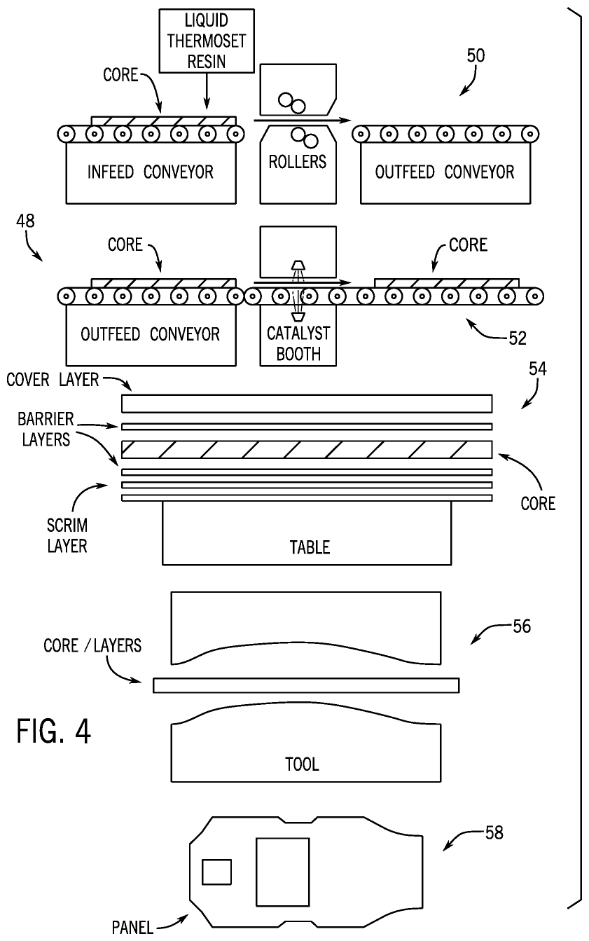

FIG. 4 is a view of a series of diagrammatical steps of an embodiment of a method 48 of manufacturing a panel that may be employed within the vehicle of FIG. 1, such as the panel disclosed above with reference to FIG. 3. First, as represented by a first diagrammatical step 50, liquid thermoset resin is applied (e.g., via a wet layup process) to a mat having fibers to form a core, and the core is compressed between rollers. During the compression process, one or more lines may be used to block the core from rolling-up. The compression process may effectively distribute the thermoset resin through the mat and control the amount of thermoset resin within the mat. For example, the weight of the thermoset resin within the mat may be about 100 to about 600 gsm, about 200 to about 500 gsm, or about 300 gsm. As previously discussed, the fibers within the mat may include PET fibers and/or any of the other fibers disclosed above with reference to FIG. 3. In addition, the thermoset resin may include MDI and/or any other thermoset resins disclosed above with reference to FIG. 3. While the core is compressed between rollers in the illustrated embodiment, in other embodiments, the core may be compressed via another suitable technique (e.g., alone or in combination with the rollers), or the compression process may be omitted.

Next, as represented by a second diagrammatical step 52, a catalyst and/or a catalyst activator (e.g., water) is applied to a first side of the core and to a second side of the core, opposite the first side. In the illustrated embodiment, the catalyst and/or catalyst activator is applied by a spray booth. However, in other embodiments, the catalyst and/or catalyst activator may be applied by any other suitable technique (e.g., alone or in combination with the spray booth). In certain embodiments, the weight of the catalyst/catalyst activator may be about 10 to about 60 gsm, about 20 to about 50 gsm, or about 30 gsm for each side of the core. With regard to the catalyst, any suitable catalyst may be used to facilitate hardening/curing of the thermoset resin. Furthermore, with regard to the catalyst activator, any suitable catalyst activator, such as water, may be used to facilitate activation of the catalyst. In certain embodiments, the catalyst and the catalyst activator are applied to the core (e.g., as a solution). Furthermore, in certain embodiments, the catalyst is included within the core (e.g., mixed with the thermoset resin), and the catalyst activator (e.g., water) is applied to the core. While applying the catalyst/catalyst activator to both sides of the core is disclosed above, in certain embodiments, the catalyst/catalyst activator may only be applied to one side of the core. Furthermore, in certain embodiments, the second diagrammatical step 52 may be omitted (e.g., no catalyst/catalyst activator may be applied to the core).

Furthermore, as represented by a third diagrammatical step 54, a first barrier layer is applied to the first side of the core, and a second barrier layer is applied to the second side of the core. The barrier layers are configured to block (e.g., substantially block or entirely block) flow of the thermoset resin from the core during a subsequent in-tool/in-mold compression and heating process. The barrier layers may include any of the component(s) and/or property/properties of the barrier layers disclosed above with reference to FIG. 3. For example, the first barrier layer may include a film, and/or the second barrier layer may include a film. Furthermore, in certain embodiments, first additional layer(s) may be disposed between the first barrier layer and the core, and/or second additional layer(s) may be disposed between the second barrier layer and the core. Any of the additional layers disclosed above with reference to FIG. 3 may be included, such as a glass mat and/or a PET scrim, for example. In certain embodiments, additional thermoset resin (e.g., the same type of thermoset resin within the core or a different type of thermoset resin) may be applied to at least one layer (e.g., at least one glass mat) before the layer is disposed between the core and the respective barrier layer. In addition, in certain embodiments, a cover layer may be disposed on an opposite side of the first barrier layer from the core. As previously discussed, the cover layer is configured to form a show surface of the panel. The cover layer may include any of the cover layer configurations disclosed above with reference to FIG. 3. Furthermore, in certain embodiments, a scrim layer may be disposed on an opposite side of the second barrier layer from the core. As previously discussed, the scrim layer is configured to form a rear surface of the panel. The scrim layer may include any of the scrim layer configurations disclosed above with reference to FIG. 3. While barrier layers, additional layers, a cover layer, and a scrim layer are disclosed above, in certain embodiments, at least one barrier layer may be omitted, at least one additional layer may be omitted, the cover layer may be omitted, the scrim layer may be omitted, or a combination thereof.

Next, as represented by a fourth diagrammatical step 56, the core and the layers are compressed and heated within a tool to form the panel. The tool may compress the core/layers with any suitable amount of force to form the panel, such as about 300 to about 1000 pounds (e.g., about 1334 to about 4448 N), about 400 to about 800 pounds (e.g., about 1779 to about 3559 N), or about 550 pounds (about 2447 N). Furthermore, the tool may apply heat to the core/layers to facilitate formation of the panel. The tool may have any suitable shape to form the panel into a complementary shape. As the thermoset resin within the core cures and/or hardens, layers in contact with the thermoset resin bond to the core. For example, the thermoset resin may couple the barrier layer(s) to the core. In addition, in embodiments including additional layer(s), the thermoset resin may flow through the additional layer(s) to the respective barrier layer(s), thereby bonding the barrier layer(s) and the additional layer(s) to the core during the panel forming process. Furthermore, in certain embodiments (e.g., in embodiments in which at least one barrier layer includes a film), the barrier layer(s) may bond to one or more respective adjacent layers (e.g., the cover layer, the first additional layer(s), the scrim layer, the second additional layer(s)). Once the panel formation process is complete (e.g., the thermoset resin is cured/hardened), the panel may be removed from the tool/mold, as represented by a fifth diagrammatical step 58. Furthermore, while the cover layer is applied before the core/layers are compressed and heated within the tool/mold in the embodiments disclosed above, in certain embodiments, the cover layer may be coupled (e.g., via an adhesive) to the panel after the panel is removed from the tool/mold.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A panel for a vehicle, comprising:
a core formed from fibers and a thermoset resin;
a first barrier layer positioned on a first side of the core, wherein the first barrier layer is configured to block flow of the thermoset resin from the core during a panel forming process; and
a second barrier layer positioned on a second side of the core, opposite the first side, wherein the second barrier layer is configured to block flow of the thermoset resin from the core during the panel forming process.

2. The panel of claim 1, wherein the fibers comprise polyethylene terephthalate (PET) fibers.

3. The panel of claim 1, wherein the thermoset resin comprises methylene diphenyl diisocyanate (MDI).

4. The panel of claim 1, wherein the first barrier layer comprises a film, the second barrier layer comprises a film, or a combination thereof.

5. The panel of claim 1, comprising a first glass mat, a first PET scrim, or a combination thereof, disposed between the first barrier layer and the core.

6. The panel of claim 5, comprising a second glass mat, a second PET scrim, or a combination thereof, disposed between the second barrier layer and the core.

7. The panel of claim 1, comprising a cover layer positioned on an opposite side of the first barrier layer from the core, wherein the cover layer is configured to form a show surface of the panel.

8. The panel of claim 1, comprising a scrim layer positioned on an opposite side of the second barrier layer from the core, wherein the scrim layer is configured to form a rear surface of the panel.

9. A method of manufacturing a panel for a vehicle, comprising:
applying a liquid thermoset resin to a mat having fibers to form a core;
applying a catalyst, a catalyst activator, or a combination thereof, to a first side of the core and to a second side of the core, opposite the first side;
applying a first barrier layer to the first side of the core, wherein the first barrier layer is configured to block flow of the thermoset resin from the core;
applying a second barrier layer to the second side of the core, wherein the second barrier layer is configured to block flow of the thermoset resin from the core; and
compressing and heating the core, the first barrier layer, and the second barrier layer within a tool to form the panel.

10. The method of claim 9, wherein the fibers comprise polyethylene terephthalate (PET) fibers.

11. The method of claim 9, wherein the thermoset resin comprises methylene diphenyl diisocyanate (MDI).

12. The method of claim 9, comprising compressing the core between rollers before applying the catalyst, the catalyst activator, or the combination thereof.

13. The method of claim 9, wherein the first barrier layer comprises a film, the second barrier layer comprises a film, or a combination thereof.

14. The method of claim 9, comprising disposing a first glass mat, a first PET scrim, or a combination thereof, between the first barrier layer and the core before compressing and heating the core, the first barrier layer, and the second barrier layer.

15. The method of claim 14, comprising disposing a second glass mat, a second PET scrim, or a combination thereof, between the second barrier layer and the core before compressing and heating the core, the first barrier layer, and the second barrier layer.

16. The method of claim 9, comprising disposing a cover layer on an opposite side of the first barrier layer from the core before compressing and heating the core, the first barrier layer, and the second barrier layer, wherein the cover layer is configured to form a show surface of the panel.

17. The method of claim 9, comprising disposing a scrim layer on an opposite side of the second barrier layer from the core before compressing and heating the core, the first barrier layer, and the second barrier layer, wherein the scrim layer is configured to form a rear surface of the panel.

18. A panel for a vehicle formed by a process comprising:
applying a liquid thermoset resin to a mat having fibers to form a core;
applying a catalyst, a catalyst activator, or a combination thereof, to a first side of the core and to a second side of the core, opposite the first side;
applying a first barrier layer to the first side of the core, wherein the first barrier layer is configured to block flow of the thermoset resin from the core;
applying a second barrier layer to the second side of the core, wherein the second barrier layer is configured to block flow of the thermoset resin from the core; and
compressing and heating the core, the first barrier layer, and the second barrier layer within a tool to form the panel.

19. The panel of claim 18, wherein the fibers comprise polyethylene terephthalate (PET) fibers.

20. The panel of claim 18, wherein the thermoset resin comprises methylene diphenyl diisocyanate (MDI).
